(19) United States
(12) Patent Application Publication
(10) Pub. No.: US 2021/0282384 A1
(43) Pub. Date: Sep. 16, 2021

(54) PLANAR BOARD WITH MAGNETIC FISHING RELEASE

(71) Applicant: David Stackhouse, Warsaw, IN (US)

(72) Inventor: David Stackhouse, Warsaw, IN (US)

(21) Appl. No.: 16/815,142

(22) Filed: Mar. 11, 2020

(51) Int. Cl. A01K 91/06; A01K 91/03

(52) U.S. Cl. CPC A01K 91/06; A01K 91/03

(57) ABSTRACT

A planer board assembly, including an elongated structural portion having a leading end and a trailing end, a first magnetic portion affixed to the trailing end and defining a permanent magnet at least partially encased in a first nonmagnetic housing, and a second magnetically attractive portion defining a magnetically attractive material at least partially encased in a second nonmagnetic housing. A length of fishing line connects the first magnetic portion to the second magnetically attractive portion. A clip is connected to the second magnetically attractive portion. A spring-biased tattle flag has a first end connected to the trailing end and a second end, wherein the spring-biased tattle flag is biased to extend the second end away from the planer board in a deployed orientation. The second end may be engaged between the first magnetic portion and the second magnetically attractive portion in an undeployed orientation.

### TECHNICAL FILED

This specification relates to the field of fishing equipment, and, more specifically, to a planar board device with a magnetic fishing release.

### BACKGROUND

Planer boards are designed to help fishermen fishing from a boat cover more area and at a distance far enough from the boat that the engine noise doesn't scare away the fish. A fisherman may use several rods at once to fish, with each respective rod fishing at a different distance from the boat. Each respective line extends outwardly from the boat to the planar board, which is hydrodynamically shaped to move away from the boat as the board moves forward through the water, and from there extends downwardly and back from the board as the boat moves along. The use of one or more planar boards thus allows the fisherman to avoid the boat's wake and to reach places they would have been unable to otherwise reach.

However, planar boards do still have a number of disadvantages. For example, planar boards have a raised flag connected to the fishing line that is lowered in response to a pull from a hooked fish, and many fishermen take a while to notice that the flag has come down, delaying their response and sometimes giving the fish a better chance of escaping. Further, the clipping mechanism holding the line to the board may take a variable amount of force to release the line, sometimes releasing prematurely and sometimes not releasing at all, depending upon how the line is secured. Thus, there is a need for an improved planar board assembly. The present novel technology addresses this need.

### BRIEF DESCRIPTION OF THE DRAWINGS

FIG. 1 is a first perspective view of a first embodiment of the present novel technology, a planar board having a magnetic release with each portion disengaged from one another.

FIG. 2 is a second perspective view of a first embodiment of the present novel technology, a magnetic release with each portion engaged to one another.

FIG. 3 is perspective view of a second embodiment of the present novel technology, a planer board having a magnetic release operationally connected thereto and having a tattle flag disposed in an undeployed orientation.

FIG. 4 is an elevation view of FIG. 3

FIG. 5 is a perspective view of the embodiment of FIG. 3 with the magnetic release decoupled and the tattle flag disposed in a deployed orientation.

Like reference numbers and designations in the various drawings indicate like elements.

### DETAILED DESCRIPTION

Before the present methods, implementations and systems are disclosed and described, it is to be understood that this invention is not limited to specific synthetic methods, specific components, implementation, or to particular compositions, and as such may vary. It is also to be understood that the terminology used herein is for the purpose of describing particular implementations only and is not intended to be limiting.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often though may not occur, and that the description includes instances where said event or circumstance occurs and instances where it does not.

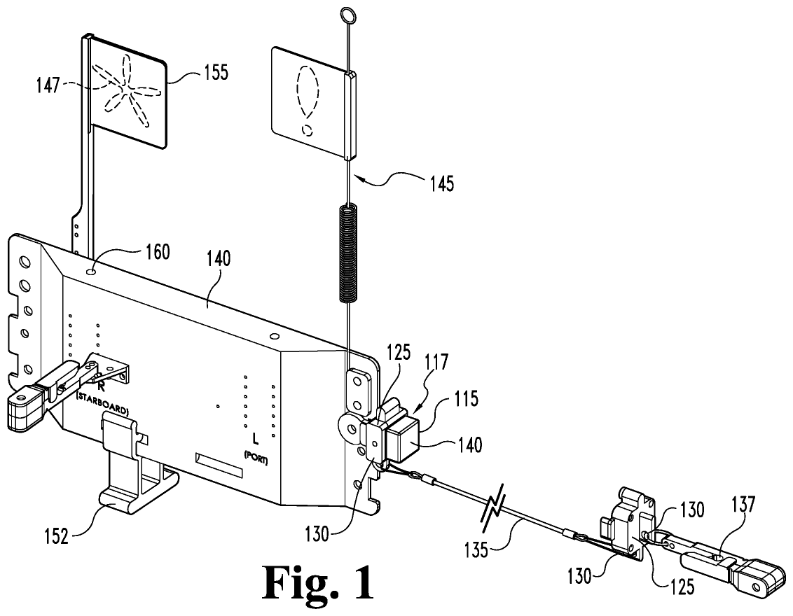

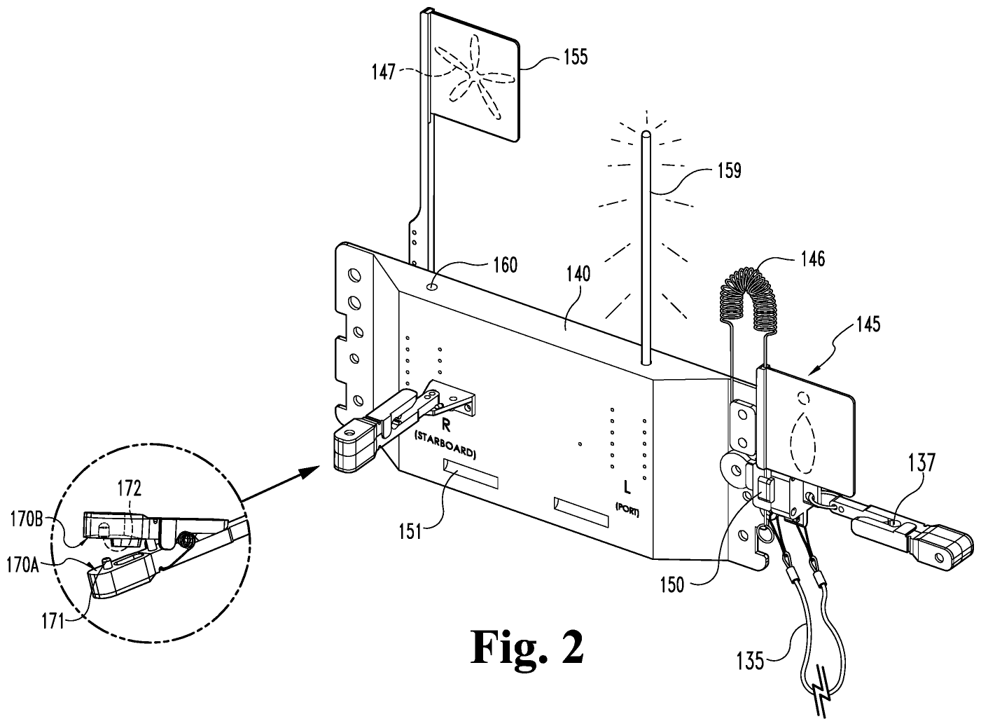

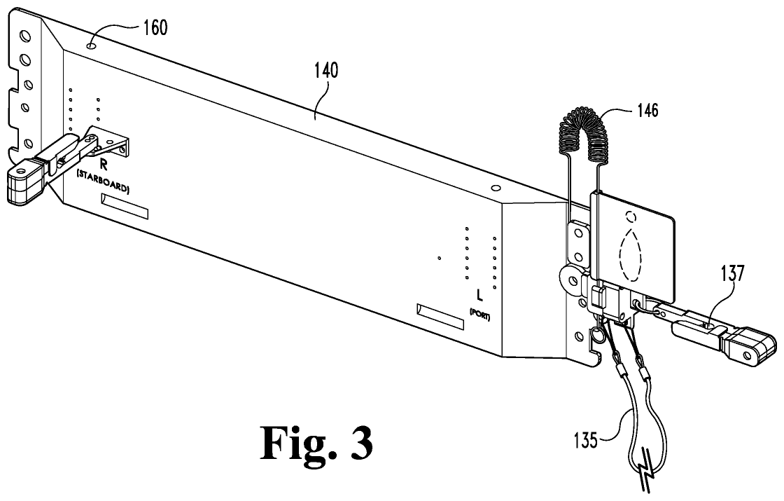

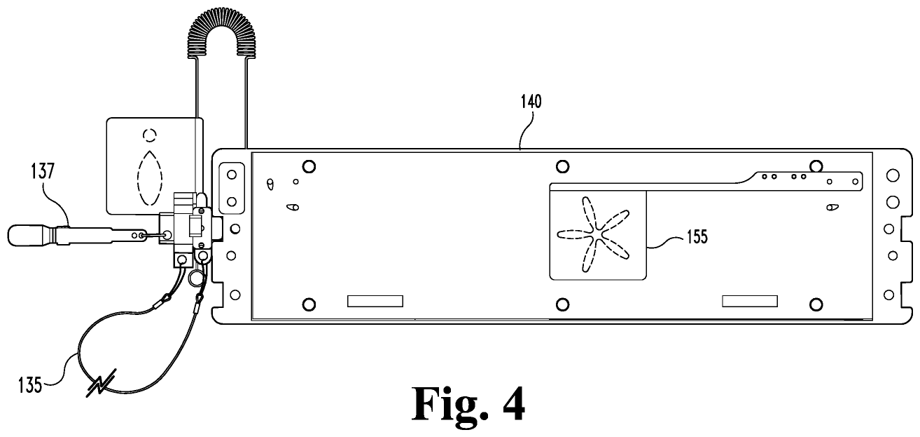

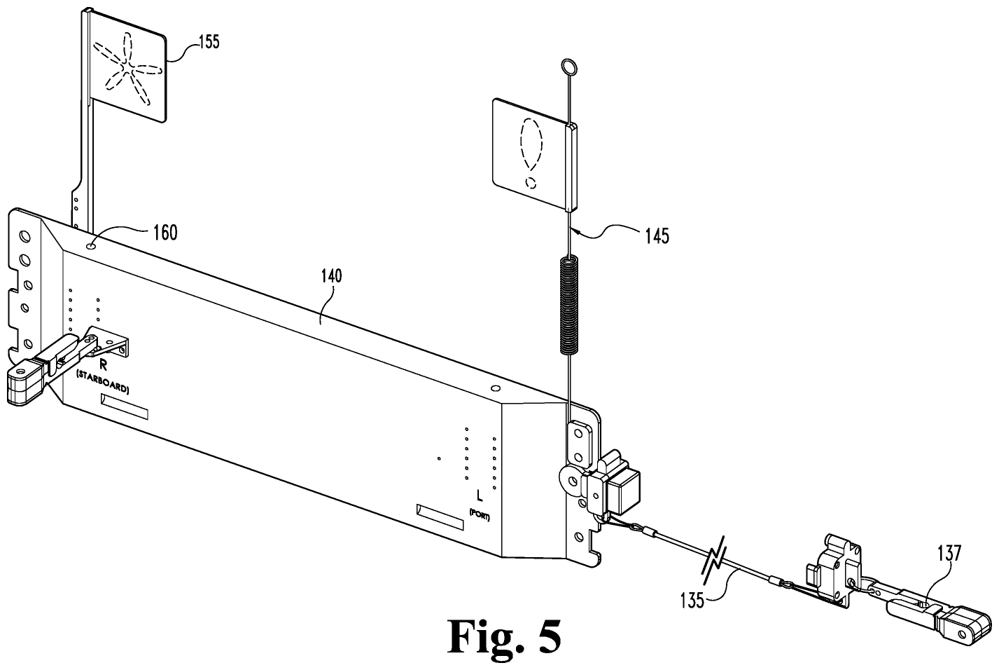

FIGS. 1-5 relate to embodiments of the present novel technology, a magnetic disconnection device 100 for use with fishing line, inline planar boards, downrigger releases, downrigger slider releases, stern planar boards, tower planar board lines or the like. In its most basic form, the device 100 includes a first permanent magnet portion 115 disposed in the first portion 117 and second magnetically attractive portion 120 embedded in the second portion 110 that may be magnetically connected to the first permanent magnet portion 115. The second, magnetically attractive portion 120 may be another permanent magnet, a ferromagnetic slug, or even a paramagnetic slug. Each respective portion 115/120 is at least partially encased in a nonmagnetic housing or shell 125. Each respective housing 125 typically further includes an aperture 130 for accepting fishing line or the like therethrough.

First and second portions 105, 110 are shaped to engage and securely couple together under the force of magnetic attraction between the magnetic portions 115, 120.

The strength of the magnetic coupling force holding the two portions 115, 120 together may be influenced by a number of factors, including the thickness of nonmagnetic or diamagnetic material covering the mating face 140 of one or both ferromagnets/paramagnet, the composition of the ferromagnetic material selected, the mass of the ferromagnetic material selected, the shape and/or thickness of the ferromagnetic/paramagnetic portion 115/120, and the like.

The magnetic coupling force between the two portions 105, 110 is typically about two pounds, but may range from one pound to ten pounds. Operationally defined, the magnetic coupling force between portions 105, 110 is sufficiently strong to hold the device 100 together, but sufficiently weak to be overcome by the force exerted by a particular type of fish once hooked.

In one embodiment, the opposing apertures 130 are each connected to fishing line 135 and a clip 137, respectively. In another embodiment, one of the portions 105, 110 is fixedly connected to a planer board 140 and the other to both a length of fishing line 135 connecting the portion 105, 110, to the planer board 140, and also to a clip 137. A tattle flag 145 extending from the planer board 140 is connected to a notch 150 formed on one of the portions 105, 110, and secured thereto by the other portion 110, 105 when magnetically coupled. The tattle flag 145 is spring biased 146 to extend away from the planar board 140 when the portions 105, 110 are decoupled, such as by a fish tugging on a line connected to the clip 137. The tattle flag 145 typically includes one or more phosphorescent markings 147 to enhance its visibility in low-light conditions, which may also be found on the planar board itself 140.

The planar board 140 typically includes at least one slot 151 and a matable storage leg clip 152 for mounting the planar board 140 to the boat instead of laying it on the floor where it may become a tripping hazard or placing it in a storage area where the planar board 140 may be prone to bending and breaking.

The planar board 140 typically includes a visual reference flag 155 operationally connected to the distal side that may be manually raised for ease of identification of the planar board when deployed. The visual reference flag 155 typically includes a phosphorescent marking 147 and more typically is visually distinct from the tattle flag 140.

Visibility of the planar board may be further enhanced by insertion of glow sticks 159 into one or more cylindrical recesses 160 formed in the planar board 140 for snugly receiving the same.

Clips 137, 150 typically include a pair of spring biased finger members 170A and 170B, with one member 170A including a post 171 protruding therefrom and the other 170B including a recess 172 sized and positioned to receive post 171 when the members 170A, 170B are urged together. The presence of the post 171 allows for more secure engagement of fishing line with the clips 137, 150 and thus decreases the likelihood of accidental disengagement of the clips 137, 150.

In operation, the distal end of the tattle flag 145 is secured between the two portions 105, no as they are magnetically coupled together. Fishing line is clipped to the planer board and to clip 137. The planer board 140 is deployed and trolled. When a fish is hooked on the line, the fish exerts sufficient force on the line to decouple the portions 105, 110, releasing the tattle flag 145 to deploy, indicating to an observer that a fish is on the line. Deployed tattle flag 145 oscillates in a waving motion when deployed to attract attention. After decoupling the portions 15, 110, the fish moves away from the planar board 140 a predetermined distance as defined by the length of the line 135. When line 135 is at full extension, an abrupt force is applied to the hook strike set the same in the fish, similar to an angler yanking his rod to set a hook. The fisherman may then proceed to catch the fish.

While the invention has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the invention are desired to be protected.

What is claimed is:

1. A magnetic fishing release, comprising:
a first magnetic portion defining a permanent magnet at least partially encased in a first nonmagnetic housing; and
a second magnetically attractive portion defining a magnetically attractive material at least partially encased in a second nonmagnetic housing;
wherein each respective housing includes an aperture formed therethrough for receiving fishing line.

2. The magnetic fishing release of claim 1 wherein the second magnetically attractive portion is ferromagnetic.

3. The magnetic fishing release of claim 1 wherein the second magnetically attractive portion is paramagnetic.

4. The magnetic fishing release of claim 1 wherein the second magnetically attractive portion is permanent magnet.

5. A planer board assembly, comprising:
an elongated structural portion having a leading end and a trailing end;
a first magnetic portion affixed to the trailing end and defining a permanent magnet at least partially encased in a first nonmagnetic housing; and
a second magnetically attractive portion defining a magnetically attractive material at least partially encased in a second nonmagnetic housing;
a length of fishing line connecting the first magnetic portion to the second magnetically attractive portion;
a first spring-biased clip connected to the second magnetically attractive portion;
a second spring-biased clip extending from the structural portion;
a spring-biased tattle flag having a first end connected to the trailing end and a second end; and
a plurality of phosphorescent markers operationally connected to the elongated structural portion and the tattle flag;
wherein each respective spring-biased clip defines a first finger pivotably connected to and biased toward mating engagement with a second finger;
wherein each respective first finger includes a peg extending therefrom toward the respective second finger and wherein each respective second finger has a recess formed therein for accepting the respective peg when the respective first and second fingers are biased together;
wherein the spring-biased tattle flag is biased to extend the second end away from the planer board in a deployed orientation;
wherein the spring-biased flag waves when deployed; and
wherein the second end may be engaged between the first magnetic portion and the second magnetically attractive portion in an undeployed orientation.

6. The assembly of claim 5 wherein each respective housing includes an aperture formed therethrough for receiving fishing line.

7. The assembly of claim 5 and further comprising an identification flag pivotably connected to the elongated structural portion.
